(19) United States
(12) Patent Application Publication
(10) Pub. No.: US 2012/0174079 A1
(43) Pub. Date: Jul. 5, 2012

(54) Systems and methods for simulating a mobile device application

(75) Inventor: Walter Jaren Luh, Sunnyvale, CA (US)

(73) Assignee: Ansca, Inc., Palo Alto, CA (US)

(21) Appl. No.: 13/135,117

(22) Filed: Jun. 23, 2011

Related U.S. Application Data
(60) Provisional application No. 61/357,923, filed on Jun. 23, 2010.

(51) Int. Cl. G06F 9/44

(52) U.S. Cl. 717/135

(57) ABSTRACT

A system is provided for simulating and creating device applications for convenient development that includes a code module configured to receive application assets for use in a device and a simulation module configured to display runtime application output results on a visual display and to preview changes on a simulated display when application code is modified. A device module may be configured to display runtime application output results on a visual display from the same source application assets used during simulation

### RELATED APPLICATIONS

This application is a non-provisional patent application, and a conversion of U.S. Provisional Patent Application Ser. No. 61/357,923 filed on Jun. 23, 2010.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Software development of native applications on computers and other devices, such as for example mobile phones, MP3 players, tablets, set-top boxes, televisions, consumer electronics etc., is an iterative process. The process is characterized by the compile-link-run cycle in which a developer writes code which must then be compiled and linked before the application can be used and/or tested. Thus, there can be significant delays between when the developer is ready to see the code in action and when the developer can actually see the code in action.

This delay is even worse in cross-development where the development environment and the target environment differ, such as for example where the development of software apps occurs on one computer but is meant to execute on another. This is most prevalent in mobile devices but also has also occurred in the development of desktop software. Typically, to aid in software development, a simulator and/or emulator is used to provide a faithful reproduction of the target environment on the development environment. These can help mitigate the delay, but still represent significant time overhead, for example the time required for installing the application in the simulated environment.

Rendering engines are responsible for the rendering of graphics and images on the screen of a computer or device. Typically, the rendering engine consists of building sets of vertices and rasterizing the geometry defined by those vertices. The rasterization can be based on solid colors or arbitrary bitmap data (such as from gradients, images, etc). This process is abstracted into a rendering stream.

Rendering engines are dependent on the platform and OS because they must go through the OS to gain access to the screen and display. In addition, they can be dependent on the functionality of the device itself For example, when the rendering engine uses hardware (GPU-based) support, the ability for the rendering engine to anti-alias is limited to direct support by the hardware. When no anti-aliasing support is available, the rendering engine will either not be able to anti-alias or will have to abandon the use of the GPU, falling back completely on a software renderer (CPU) which results in reduced performance and increased battery drain.

The graphics model determines, among other things, how a scene is defined and how the object in a scene relate to one another. Many graphics models use the so-called Painter's model of rendering in which objects are stored in a tree-like hierarchy and objects encountered first (in a depth-first traversal) appear below those encountered later. The position in the hierarchy thus determines the order in which objects are drawn, and thus which objects appear above another.

Most graphics models use transformation matrices to enable scaling, translation, and rotation of objects. Because matrix multiplication is non-associative, the order in which transformations are applied affects the outcome, e.g. a translation followed by a rotation results in a different transformation from a rotation followed by a translation. As a result, transformations are difficult to represent in an intuitive fashion, making them very error-prone and difficult to troubleshoot.

Typically, an application is written by writing code that then links against a framework. These frameworks provide functionality that simplifies software development. Most frameworks require you to write the application code in the same language as the framework itself was written. They also rely on native, platform-specific user-interface elements.

Sometimes the framework comes in the form of a runtime engine, such as the 3-D Quake rendering engine. The developer then extends the engine as with any framework but unlike a normal library. In a normal library, the use of the library's functionality is driven by the application's flow of code. In a runtime engine, the runtime defines how the main flow of code and the developer adds functionality at certain defined extension points. This code determines the application behavior.

Thus, it would be very useful if there existed an approach that allowed a user to create application code for mobile applications where there is no significant delay between when the developer is ready to see the code in action and when the developer can actually see the code in action. As will be seen, the invention provides such an approach in an elegant manner.

### BRIEF DESCRIPTION OF THE DRAWINGS

FIG. 1 is an exemplary flow chart of a method configured according to one embodiment.

FIG. 2 is an exemplary system configured according to one embodiment.

FIG. 3 is an exemplary flow chart of a method configured according to one embodiment.

FIG. 4 is an exemplary flow chart of a method configured according to one embodiment.

FIG. 5 is an exemplary flow chart of a method configured according to one embodiment.

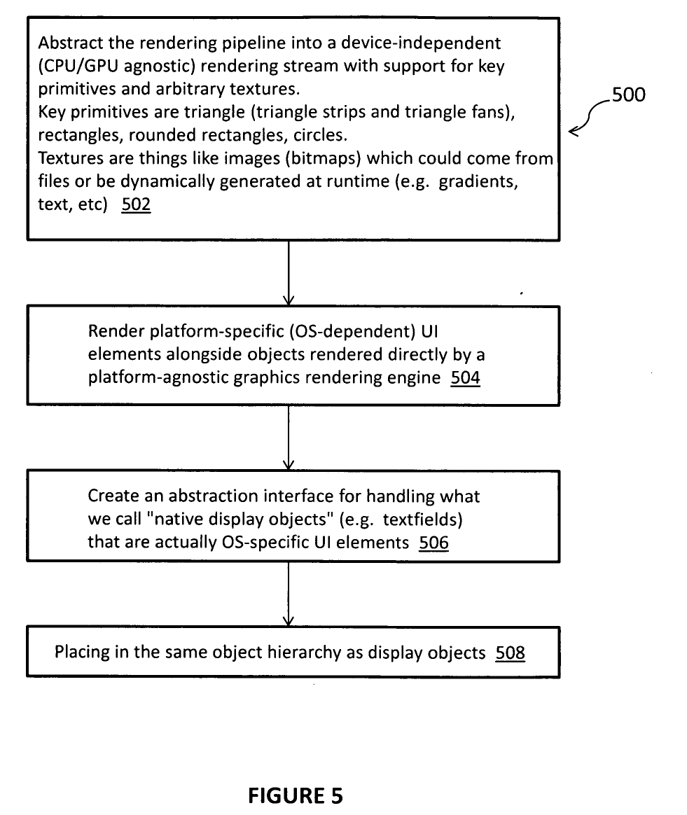

FIG. 6 is an exemplary system configured according to one embodiment.

### DETAILED DESCRIPTION

The invention is directed to a novel development approach for creating and displaying outputs of software applications such as for example mobile applications (“Mobile Apps”) for use on portable devices during development without significant delay compared to prior approaches. In the following description, numerous specific details are set forth in order to provide a thorough understanding of the present invention. However, it will be apparent to one skilled in the art that the present invention can be practiced without these specific details. In other instances, well known circuits, components, algorithms, and processes have not been shown in detail or have been illustrated in schematic or block diagram form in order not to obscure the present invention in unnecessary detail. Additionally, for the most part, details concerning networks, interfaces, computing systems, and the like have been omitted inasmuch as such details are not considered necessary to obtain a complete understanding of the present invention and are considered to be within the understanding of persons of ordinary skill in the relevant art. It is further noted that, where feasible, all functions described herein may be performed in either hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . ”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

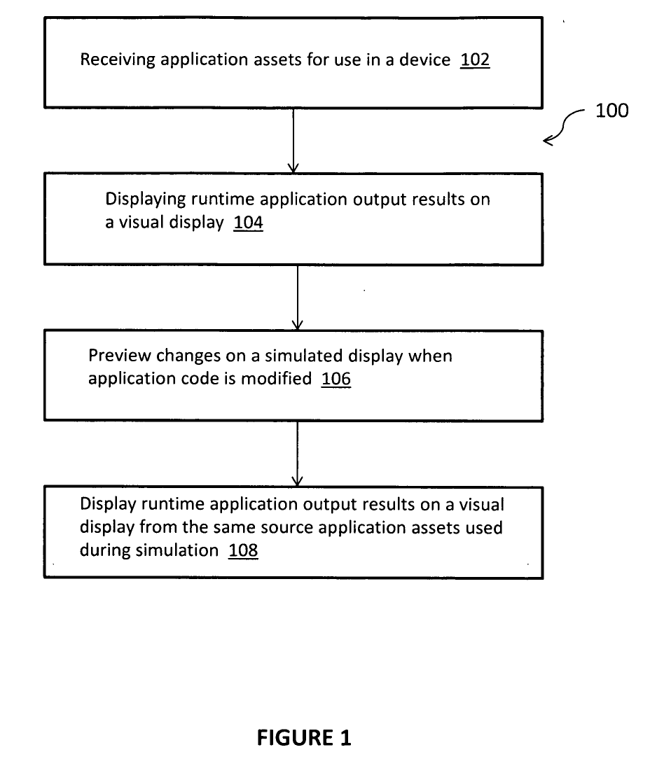

The systems and methods described herein provide an accurate and efficient way to build and simulate mobile applications to allow users of such applications to quickly and conveniently configure code and then view the resulting visual output without significant wait time or delay. In various embodiments, the described systems and methods according to the flow chart 100 of FIG. 1 can comprise receiving application assets for use in a device 102, displaying runtime application output results on a visual display 104, previewing changes on a simulated display when application code is modified 106, and displaying runtime application output results on a visual display from the same source application assets used during simulation 108.

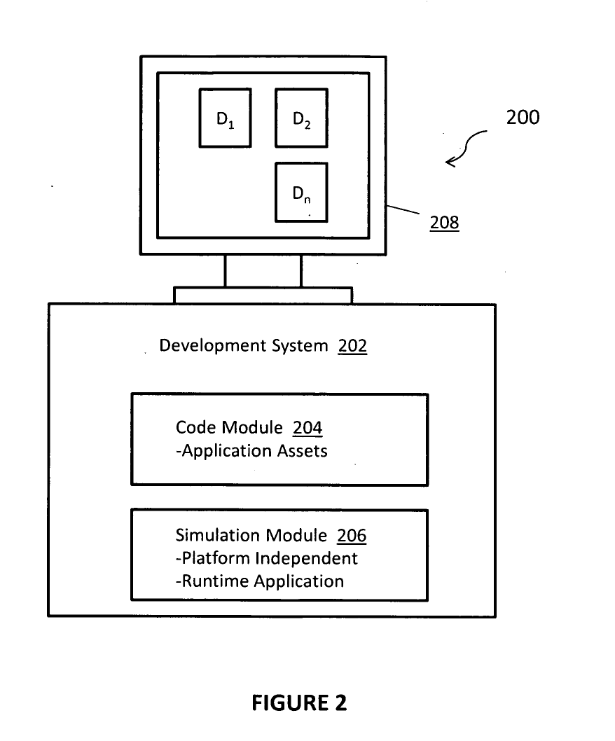

Referring to FIG. 2, an example of a system 200 configured according to the invention is illustrated. In this exemplary system, a development system 202 includes a code module 204 configured to receive application assets, and a simulation module 206 configured to simulate runtime applications in a platform independent manner on a display 208, and may also display multiple runtime applications D₁, D₂, . . . Dₙ at once, and these may be essentially the same application shown simulated on different formats, such as Android, iOS, etc., for convenient review by a developer while developing applications for use on mobile devices for example.

As used herein, the term “application” refers to any computer-based application or web-based application. Examples of web-based applications can be retailer websites, enterprise websites, information websites, and any other websites. Examples of computer-based applications can be games, word processing, mobile applications (known as “apps”), software, tax software, or other computer programs.

The invention is directed to an approach for application developers to more conveniently create a view the outcomes of a running application during development. A user may then be able to view an application output after drafting code without significant delay. In one embodiment, a system is configured for simulating and creating device applications that includes a code module configured to receive application assets for use in a device. A simulation module is configured to display runtime application output results on a visual display and to preview changes on a simulated display when application code is modified. The system can then display may then be utilized to visually display a runtime application output results from the same source application assets used during simulation. The simulation module may provide a substantially similar reproduction of the runtime experience of the application assets as compared to the device module to accurately show a user the output. The simulation module may further configured to simulate an application on multiple different platforms and different devices of a particular platform. The device module may further configured to activate and deactivate device hardware by automatically detecting its usage by the application code. The device module may be further configured to securely run application code provided during device builds, detecting against modified application code. The display of runtime application output may result on a visual display may include the animation of at least one visual object.

The simulation module and the device module may be further configured to use a graphics model in which there is an order-independent way to apply 2-D transformations to graphical objects while still preserving the full capabilities of traditional 2-D transformations. The simulation module and the device module may be further configured to perform fast vertex generation and shading of key primitives. This may include rasterizing colors and textures into those primitives, and may further provide fast hit-testing of those key primitives for interactivity purposes.

The simulation module and the device module may be further configured to perform anti-aliasing procedures on vector objects, such as key primitives, and may also perform rendering operations using a graphics model, and may also be further configured to render platform-specific user interface elements together with objects rendered using the configuration above configuration.

The application assets may include one or more of application code, images, sounds, data or other assets. The device may include but is not limited to a mobile device, a desktop computing system, a tablet, a netbook, a set-top box or other device. The runtime experience may include an application workflow, a user interface, a game interface, multimedia data, audio data and animation of at least one visual object.

Generally, one embodiment may allow a user to achieve the ability to preview in real-time the application in a device simulator; iteratively modify the application's code, and instantly update it in the device simulator. The simulator can automatically detect changes to any application-related files. If changes are detected, the simulator can automatically re-launch the real-time preview/simulation of the app. Traditionally, to preview an application in the device simulator, you must compile and link the project assets into an exe that runs in the simulator. Then, you must install the exe into the simulator OS and launch it. In a system configured according to the embodiments described herein, device simulator can be configured that uses the same simulation engine used by the executable application (exe) on the device. This allows to skip the above steps (see next bullet) and load the project at real-time speeds. A simulator configured according to the invention does not need to do a compile/link, install an app into a simulated OS, or launch a simulated OS environment; it relies on defined OS services instead.

In one embodiment, native applications may be configured to run on a separate device that runs the same as on the simulator. For example, an application can be connected or otherwise communicate with the development system, and the application can be run on the device without significant delay in compiling and other functions. The application may run on Lua™ code, which is the essential logic for the simulation module, and those skilled in the art will understand that other code may be used.

Generally, the engine is the executable, and consists of platform-independent and platform-dependent portions. A core module of the system, used commercially as the “Corona core” as the platform-independent layer. The Corona core relies on certain OS/platform/device services and functionality:

basic OS services like file loading, memory allocation, etc.

image loading

access to the display and graphics HW (opengl-es)

timers for creating animation

loading and playing sound files.

user-driven events, e.g. touch events, orientation events

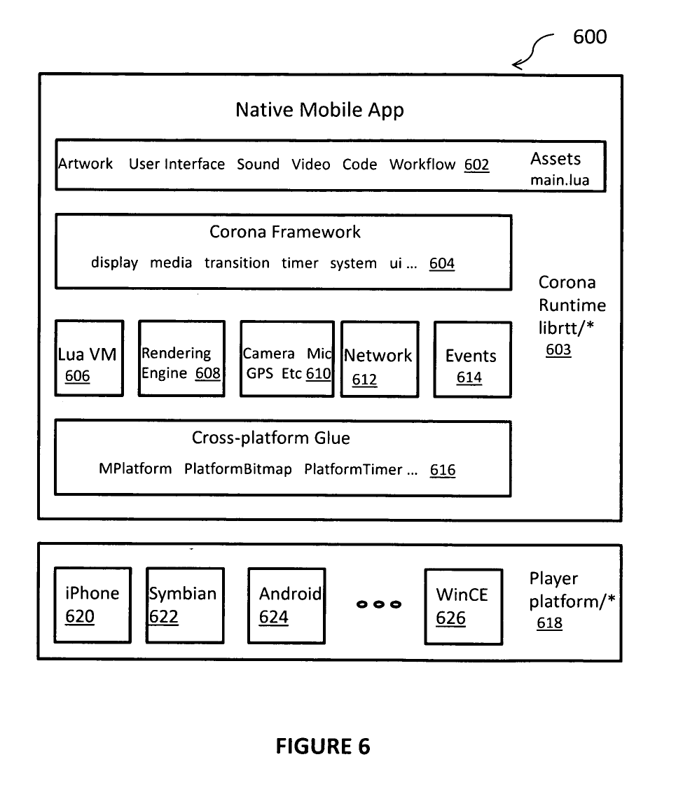

For each platform, we have an interface that provides access to these services in a platform-independent manner. The logic is defined by a scripting language such as for example Lua™ code which controls how the application behaves, what is displayed on screen, how events are handled, etc. It uses functionality provided (vended) by the Corona engine. The major differences between the Corona engine used by the simulator and the Corona engine that is part of the native device exe is the form of the logic layer. In the simulator, the raw Lua code is not compiled; it is interpreted, the Corona engine is contained in the simulator, separated from the project, when launching an application, looks to the project folder. On the device, the Lua code may be compiled for optimal performance. The Lua code may be copiled into bytecode and run on a virtual machine on the device, or ahead-of-time compilation or just-in-time compilation may also be performed. The project assets may be bundled with the Corona engine to create an executable application (see Application architecture diagram FIG. 6). Also, when launching, loads project assets packaged in the application.

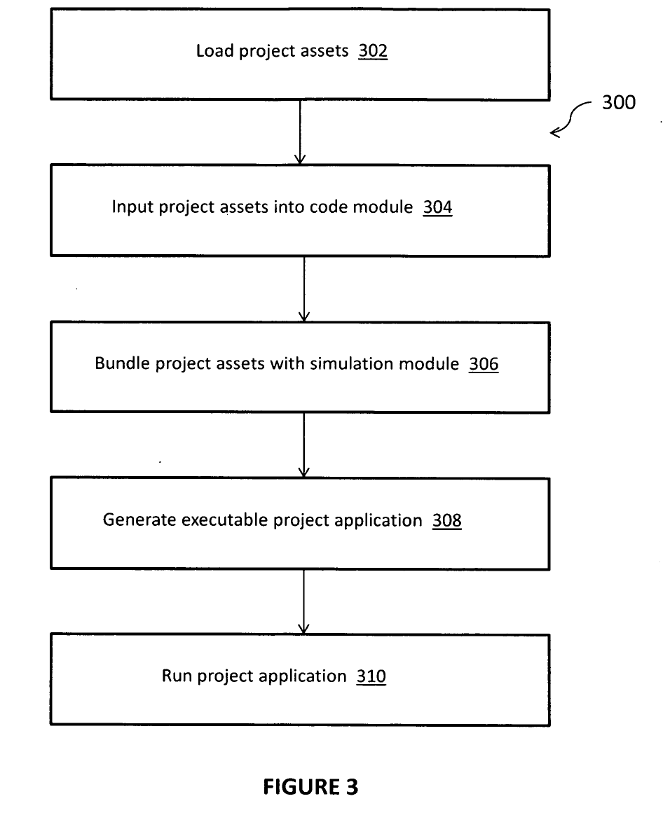

In operation, referring to FIG. 3, project assets are loaded into the code module, load project assets of step 302. The project assets into code module in step 304. Then, the project assets are bundled with simulation module 306, and an executable project application is generated in step 308. A user may then run the project application in step 310. executing the application

There are differences in the inputs that are fed in depending on the device or the simulator:

In one embodiment of the simulator, the inputs are:
raw source code
assets (e.g. image files, audio/sound files, data files, etc)

On the device, the inputs are:
source code compiled into intermediate format, e.g. byte codes
assets (e.g. image files, audio/sound files, data files, etc) that may have undergone an optional pre-processing optimization stage

In both cases, there may be a pre-designated portion of the input that designates the starting point for execution; this portion of code determines what other code in the input is executed. In the simulator, this is a designated file (e.g. main.lua) execution code. On the device, the corresponding bytecode is executed instead of the raw source; the bytecode may reside in a file or may reside in an equivalent form packaged in an archive file.

In one embodiment, a system can simulate the application running in multiple devices running on different platforms, where a metadata file is defined for each device. This metadata is used to determine the size of the drawable region in which Corona renders graphics, the image file that specifies the skin which gives the appearance that the drawable region is inside the device, and the hardware capabilities of the device

For enforcement of security of native applications when a native device exe is created, the Corona engine may be modified in a manner so that it can only run the compiled Lua code contained in the corresponding project. A signature is enabled in the Corona engine that uniquely ties it to the compiled code.

To provide order-independent (associative) transform model with support for full 2-D affine transforms, one embodiment is included to comply with Apple Corporations' Quartz 2D reference. Quartz2D is based on PDF, which is based on Adobe Corporation's rendering model, dating back to Postscript. Flash is the same. See for reference: http://developer.apple.com/iphone/library/documentation/GraphicsImaging/Conceptual/drawing withquartz2d/dq_affine/dq_affine.html#//apple_ref/doc/uid/TP30001066-CH204-SW1

The standard 2-D transformations have the following properties and limitations. The standard graphics model relies on 2-D affine transformation matrices. The canonical transformation of an object (in a hierarchy) is the product of its ancestor's matrices and the object's own transformation. Transformation matrix math algorithms are non-associative, so the order of operations matters. This results in counter-intuitive programming models which typically just expose you to the matrix math operations directly

Typically, the user wants to modify the scale and/or rotation about the same point of an object. They also want to translate the object without losing the ability to later scale and rotate the object. Therefore, by storing scale, rotation, and translation information on a per-object basis, a more intuitive graphics model is possible. This information is used to lazily create transformation matrices for a given object, using a defined order to create the matrix, e.g. scale, then rotate, then translate. A custom user-defined affine transformation matrix can be applied after these operations to achieve the capabilities of affine transform matrices like skew.

Each object in the hierarchy may have a local origin and a reference point. The local origin is the position of that object's origin relative to its parent. The reference point is a position relative to that local origin; typically, it is (0,0) which means the reference point is the same position as the local origin. The reference point determines the point about which rotations and scaling occur.

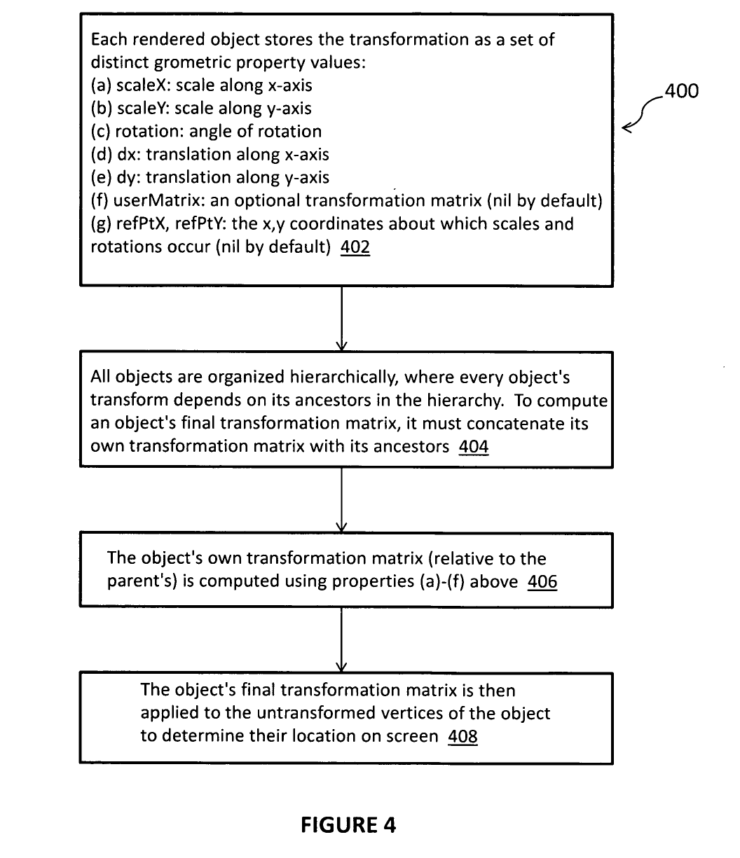

In operation, referring to FIG. 4, a flow chart 400 of the operation is illustrated.

Each rendered object stores the transformation as a set of distinct geometric property values in step 402:
(a) scaleX: scale along x-axis
(b) scaleY: scale along y-axis
(c) rotation: angle of rotation
(d) dx: translation along x-axis
(e) dy: translation along y-axis
(f) userMatrix: an optional transformation matrix (nil by default)
(g) refPtX, refPtY: the x,y coordinates about which scales and rotations occur (nil by default)

The system may enable these values to be changed independently.

In step 404, all objects are organized hierarchically. Therefore, every object's transform depends on its ancestors in the hierarchy. To compute, an object's final transformation matrix, it must concatenate its own transformation matrix—that is, the transform relative to the parent—with its ancestors:

In equation form, the object's final transform matrix=[M_root]* . . . * [M parent]*[M_object]

In step 406, the object's own transformation matrix (relative to the parent's) is computed using properties (a)-(f) above. Here is an exemplary pseudo-code

matrix = identity
if ( nil != refPtX && nil != refPtY ) {
matrix = Translate( −refPtX, −refPtY ) * matrix;
}
matrix = Scale( scaleX, scaleY ) * matrix;
matrix = Rotate( rotation ) * matrix;
if ( nil != userMatrix )
{
matrix = userMatrix * matrix
}
if ( nil != refPtX && nil != refPtY ) {
dx += refPt−>x;
dy += refPt−>y;
}
matrix = Translate( dx, dy ) * matrix;

where Translate( ), Scale( ) and Rotate( ) are functions that generate a translation, scale, and rotation matrices respectively.

In step 408, the object's final transformation matrix is then applied to the untransformed vertices of the object to determine their location on screen.

In one embodiment, anti-alias vector objects are provided when the GPU does not provide direct anti-aliasing support. There is included a multisampling-based algorithm, weighted offsets. A general algorithm is to generate percentage pixel coverage in the accumulation buffer. To compensate for lack of accumulation buffer and lack of direct HW support for anti-aliasing, a trick known as dst-alpha may be used to simulate the accumulation buffer. An algorithm using this approach may simulate accumulation and achieve coverage.

According to one embodiment, coverage is generated by submitting the same set of vertices in multiple passes to the hardware. For each weighted offset, hardware is used to translate the same set of submit vertices by the offset. The pixels of the accumulation buffer inside the triangles defined by these vertices get a weight added to them. After all passes are done, a bounding rectangle is drawn, filling it with the color or texture defined elsewhere). The accumulation buffer value may also be used as the alpha, so that only the intersection of the rectangle and the non-zero region in the accumulation buffer get drawn. This is effectively the anti-aliased shape.

In one embodiment, generally, there's an array of points. These points define the offsets. For each point, there is a weight. These weights must be normalized so they sum to one. Thus, these points form the weighted offset.

The first bullet is about drawing each object multiple times according to the weighted offset. The drawing gets accumulated into the single alpha channel of the framebuffer (or accumulation buffer, if present). This creates an alpha mask that is anti-aliased.

The second bullet is about how we the object gets drawn. The object may be drawn a final time and modulate it by the alpha mask from the first bullet. The abstract the rendering pipeline into a device-independent (CPU/GPU agnostic) rendering stream with support for key primitives and arbitrary textures. In one embodiment, key primitives are triangle (triangle strips and triangle fans), rectangles, rounded rectangles, circles. Textures may include items such as images (bitmaps) which could come from files or be dynamically generated at runtime (e.g. gradients, text, etc). Render platform-specific (OS-dependent) UI elements may occur alongside objects rendered directly by a platform-agnostic graphics rendering engine. An abstraction interface can be created for handling what we call “native display objects” (e.g. textfields) that are actually OS-specific UI elements. Then, implementations of these native display objects may be made for each platform. These native display objects may be constructed to obey the same rules as normal display objects. These may be placed in the same object hierarchy as display objects.

At render time, we calculate the final screen position of the “native display object” by calculating the final transformation matrix as with a normal display object. We then use that transform matrix and apply it to the native display object using OS-specific API calls.

Typically, native display objects are rendered above all non-native display objects. This isn't strictly necessary, but typically this results in better performance. On some platforms, they must be rendered above.

In another embodiment, there may be a periodic timer that drives the animation loop. Such a approach could abstract the timer functionality of the OS to make it cross-platform. At each timer tick, a rendering event could be sent to the logic layer (i.e. the Lua or scripting code). If a listener (a function callback in the Lua/script) is registered for rendering events, then that listener can modify display objects. If display objects are modified, then the screen may be updated based on those changes. Display objects can also be modified by user-driven events (e.g. touch events, accelerometer events, GPS events, system events, etc) that the device makes available. If there are listeners registered for those events, those listeners will get called between timer ticks

In another embodiment, portions of hardware on a device can be activated and deactivated depending on the presence/absence of user-supplied listeners/callbacks. Examples include orientation detection, accelerometer events, GPS/heading events, multitouch events, etc. The benefit is reduction of battery drain; lengthen battery life b/c certain software events are tied to hardware that drains the battery. For example, if the user (developer) does not register for GPS event, then the GPS hardware is turned off. If the user does register, then GPS is automatically turned on. On iPhone, you have to manually do this. Also, behaviors may be added to objects rendered by the graphics rendering engine. Some or all objects may be rendered by the graphics rendering engine as first-class objects.

The application state may be defined as the data associated with the application. This data includes objects that appear on screen. The application state can change based on events. Different script blocks can be registered with particular events. These events can be driven by the user, the runtime, or the OS. User events may be interactive. They can be mouse clicks, touches, orientation changes, accelerometer, etc. Runtime events may be part innate to the engine. The typical one is the timer event that drives animation. OS events may be driven by the system such as application launch, low memory, interruptions, etc. When the application state changes, the rendering engine will update the screen if there are visible changes.

All objects rendered on the screen are what we call “display objects”. These objects are part of a hierachical scene.

When the application state changes, the rendering engine may update the screen based on a two step process:

Build: Building scene, e.g. calculating vertices, applying transforms. Anytime, a user may create a display object or change a property of a display object, the user is modifying the scene.

Draw: Submitting geometry to the renderer, e.g. OpenGL, DirectX, SW renderer, etc.

Referring to FIG. 6, an exemplary system is illustrated as an architectural bloc diagram 600. The system, native mobile app 600, includes a layer of assets 602, that may include artwork, user interface, sound, video, code, work flow and other assets. The Corona runtime module 603 includes the framework 604 of display, media, transition, timer, system, user interface (UI), etc. The runtime module further includes a Lua™ virtual machine (VM) 606, rendering engine 608, devices 610 including camera, microphone, GPS, etc., network 612 and events 614 modules. A cross platform glue 616 is configured to allow runtime to operate among different platforms with MPlatform, a platform bitmap, a platform time, etc. The different platforms iPhone 620, Symbian 622, Android 624, WinCE, etc. are on the player platform 618.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet-related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Finally, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

1. A system for simulating and creating device applications, comprising:
a code module configured to receive application assets for use in a device;
a simulation module configured to display runtime application output results on a visual display and to preview changes on a simulated display when application code is modified; and
a device module configured to display runtime application output results on a visual display from the same source application assets used during simulation.

2. A system according to claim 1, wherein the simulation module provides a substantially similar reproduction of the runtime experience of the application assets as compared to the device module.

3. A system according to claim 1, wherein the simulation module is further configured to simulate an application on multiple different platforms and different devices of a particular platform.

4. A system according to claim 1, wherein the device module is further configured to activate and deactivate device hardware by automatically detecting its usage by the application code.

5. A system according to claim 1, wherein the device module is further configured to securely run application code provided during device builds, detecting against modified application code.

6. A system according to claim 1, wherein the simulation module and the device module are further configured to use a graphics model in which there is an order-independent way to apply 2-D transformations to graphical objects while still preserving the full capabilities of traditional 2-D transformations.

7. A system according to claim 1, wherein the simulation module and the device module are further configured to perform fast vertex generation and shading of key primitives, including rasterizing colors and textures into those primitives, as well as provide fast hit-testing of those key primitives for interactivity purposes.

8. A system according to claim 1, wherein the simulation module and the device module are further configured to perform anti-aliasing procedures on vector objects, such as key primitives.

9. A system according to claim 1, wherein the simulation module and the device module are further configured to perform rendering operations using a graphics model.

10. A system according to claim 1, wherein the simulation module and the device module are further configured to render platform-specific user interface elements together with objects rendered using the configuration according to claim 7.

11. A system according to claim 1, wherein the application assets include any of: application code, images, sounds and data.

12. A system according to claim 1, wherein the device includes but is not limited to any of: a mobile device, a desktop computing system, a tablet, a netbook and a set-top box or other device.

13. A system according to claim 1, wherein display of runtime application output results on a visual display includes animation of at least one visual object.

14. A system according to claim 2, wherein the runtime experience includes any of: an application workflow, a user interface, a game interface, multimedia data, audio data and animation of at least one visual object.
